(19) United States
(12) Patent Application Publication
(10) Pub. No.: US 2005/0197184 A1
(43) Pub. Date: Sep. 8, 2005

(54) System for regulating use of an electronic device

(76) Inventor: Steven Ahlquist, Sandy, UT (US)

Correspondence Address: Michael W. Starkweather, 9035 S. 1300E, Suite 200, Sandy, UT, 84094, US

(21) Appl. No.: 10/745,515

(22) Filed: Dec. 30, 2003

(51) Int. Cl. G06F 19/00; A63F 9/24

(52) U.S. Cl. 463/29

(57) ABSTRACT

An electronic device control system for controlling access to an electrical device. The control system includes a controller module functionally coupled to the electrical device, designed to limit access to the electrical device. The controller module may include a power plug designed to access electrical power for the controller module. There may also be a plug locking mechanism coupled to the controller module, and designed to hinder removal of the electrical device power cord when inserted therein. There may also be an interface screen designed to allow programming of the controller module. The control system may also include a tracking module designed to keep track of the amount of reward time a user has available to use in accessing the electronic device. Additionally, the control system may also have a reward module designed to enable a manager to add reward time to a user for performing selected activities.

### BACKGROUND OF THE INVENTION

1. Field of the Invention

The present invention relates generally to a system for regulating the use of an electronic device. Specifically, there is an electronic reward system that regulates the use of, for example, the television, computer, Play Station®, Nintendo®, etc.

2. Description of the Related Art

Since the introduction of the personal computer (PC) users have been playing games thereon. Since the introduction of the PC, the proliferation of computer games has grown at an accelerated rate. So much so, those specialty game computers, such as Nintendo® or Play Station®, have developed strong niche markets.

As a result of this proliferation of PC games and such, people, especially young teenage men, have become almost addicted to playing the computer games. One survey estimates that some people spend more time playing computer games than watch television, which amounted to literally thirty seven hours or more a week. As a result, parents are clamoring for a way to control or limit the amount of time an adolescent may spend on the computer, television or other similar entertainment devices.

The following patents are offered to assist in understanding the state of the art known to be at least somewhat related to the present invention, and are herein incorporated by reference for their supporting teachings:

U.S. Pat. No. 6,361,325, is a child sleep-time timer and clock device.

U.S. publication no.: U.S. 2003/0005072 A1, is a system and method for monitoring computer usage.

U.S. Pat. No. 6,478,583, is a time monitoring portable game system.

U.S. publication no. 2003/0008268 A1, is a network-assisted behavior management system.

It is believed that none of the above incorporated patents teach, alone or in combination, the present illustrated embodiments of the invention.

### BRIEF SUMMARY OF THE INVENTION

The present invention has been developed in response to the present state of the art, and in particular, in response to the problems and needs in the art that have not yet been fully solved by currently available technology. Accordingly, the present invention has been developed to provide system for regulating the use of an electronic device. Specifically, there is an electronic reward system that regulates the use of, for example, the television, computer, Play Station®, Nintendo®, etc.

One aspect of the illustrated embodiment is to provide an electronic device control system for controlling access to an electrical device. The control system includes a controller module functionally coupled to the electrical device, designed to limit access to the electrical device. The controller module may include a power plug designed to access electrical power for the controller module. There may also be a plug locking mechanism coupled to the controller module, and designed to hinder removal of the electrical device power cord when inserted therein. There may also be an interface screen designed to allow programming of the controller module. The control system may also include a tracking module designed to keep track of the amount of reward time a user has available to use in accessing the electronic device. Additionally, the control system may also have a reward module designed to enable a manager to add reward time to a user for performing selected activities.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic view of a system for regulating the use of an electronic device.

FIG. 2 is a flow chart illustrated major steps in operation of the system illustrated in FIG. 1.

FIG. 3 is a representation of a screen illustration for making sections requested in FIG. 2.

FIG. 4 is another screen illustration related to selections from FIG. 2.

FIG. 5 is yet another screen illustration related to exercise rules.

FIG. 6 is yet another screen illustration related to learning rules.

FIG. 7 is yet another screen illustration related to seasonal exercise rules.

FIG. 8 is yet another screen illustration related to continuous use exercise rules

### DETAILED DESCRIPTION OF THE INVENTION

Reference throughout this specification to “one embodiment,” “an embodiment,” or similar language means that a particular feature, structure, or characteristic described in connection with the embodiment is optionally included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

Many of the functional units described in this specification have been labeled as modules, or systems in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

For the purpose of this disclosure, a user is defined as a person that is to have limited access to electronic games or devices and will be subject to the governing rules. A manager is a person that will set the governing rules that determine the amount of time the user(s) may have to access the electrical devices. The manager is also the person that will determine how many time units of reward have been earned and will credit those time units to the appropriate user. Time units are defined as equal amounts of time, but are flexible enough in definition to be described as being minuets, hours, half days, etc.

A general description of the goal of the present invention is to provide a control device that will allow a parent to regulate the amount of time their child can use the computer playing games. Rules are set up so that the child knows that if they go for a 30 min. walk that they will receive an award for a certain amount of time to play their computer game, but an unlimited amount of time. The control device will automatically limit the amount of time that the power will be connected to the computer.

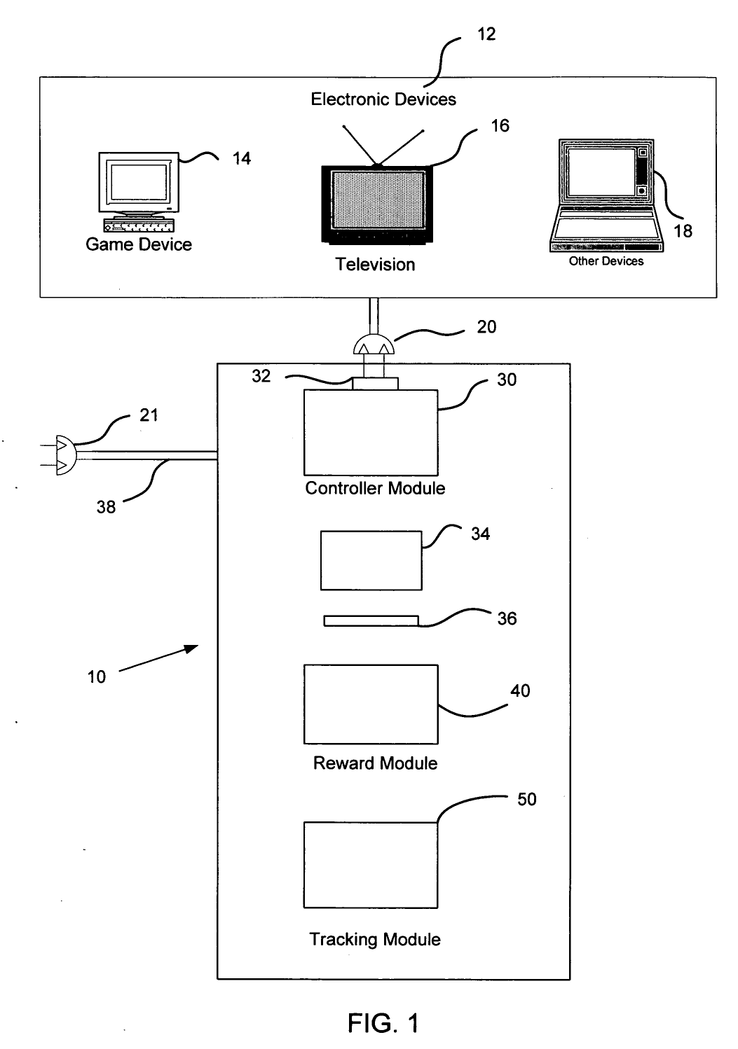

Referring to FIG. 1, there is illustrated one embodiment of the illustrated electronic device control system 10. Specifically, there is illustrated various electronic devices 12, which include, for example, a computer operated game 14, like Solitaire, a television 16, that enables devices like Nintendo®, and a laptop 18, which is intended to represent any other electronic device that is intended to be regulated by the presently described invention. There is a power plug 20, which represents any power cord 20 originating from any of the electrical devices 12. The power plug 20 is intended to be coupled to the device control system 10, which in turn has a power plug 38 that is intended to have the plug 21 placed into an outlet to secure power for the control system 10, which in turn provides power to the electronic device(s) 12 when certain conditions are met as described below.

FIG. 1 further illustrates the use of a control system 10. The control system 10 includes a controller module 30, which is intended to control the electrical power supply from the outlet, through the control system 10 and to the power plug 20, which in turn will supply power to the electronic device 12. The controller module 30 is activated by a user entering their personal identification or code and accessing the tracking module 50, which will then determine how much time is available for the particular user to use the electronic device 12. The controller module 30 will record how much time has been used by the user and subtract from their time account and record that new time amount to be used for their next access to the controller module 30. The controller module 30 will shut off the power through the control system 10 when the user has used all of their allocated time for use of the electronic devices 12.

In one embodiment, the control system 10 may optionally include a plug locking mechanism 32, which is designed to securely hold the power plug 20 therein, to prevent easy removal therefrom. One way for ensuring only authorized removal occurs is to use a pass code or locking system incorporated into the locking mechanism. For example, this locking mechanism 32 could be as simple as a combination lock, or as complex as an electronic locking mechanism being unlocked from entering codes on a touch screen 34. The main purpose is to prevent bypassing the control system 10. The locking mechanism 32 is not required to be coupled to the controller module 30 as illustrated, but is intended to be part of the control system 10.

Additionally, in another embodiment, the control system 10 will include some sort of input screen 34, which would function much like a personal digital assistant or PDA using touch screen type functioning. The screen 34 is intended to provide information and queries, like establishing access codes for removal of the plug locking means 32, manager access codes, or user access codes. Additionally, the screen 34 enables multiple users to access the control system 10. For example, when two or more people are enrolled in the system 10, they will have different reward rules and different time usage on the electronic devices 12. The screen 34 allows for each user to have an individual sign-on code to enable only their allocated time to be used when using the electronic devices 12. Additionally, the manager of the system 10 will use the screen to add on reward time units for the users for performing authorized activities as will be made clearer herein below.

There is also illustrated in FIG. 1 a reward module 40 that is part of the system 10. The reward module 40 is illustrated to be an imbedded software program, and is designed to use the same screen 34 and other features illustrated therein. A user would simply log on with an individual code that would be entered on the touch screen 34, or some similar fashion of entering information. Thus, the user could activate the controller module 30 to recognize the particular user, access the stored time units for the user available for the electronic device 12 usages, and enable power to be supplied to the selected electronic devices 12.

In another embodiment, similar to the controller module 30, the reward module 40 optionally could be a separate hardware piece that has a separate screen and other features. In operation, the user will access the reward module 40, interact with the screen 42, and have reward time units assigned to the individual in accordance to the specific rules, which are described below.

FIG. 1 additionally teaches implementing another embodiment of the invention that includes a tracking module 50. The tracking module 50 may take the form of software or smart card, credit card or memory card. If the tracking module 50 is in a card form, a card reader 36 would be mounted to the control system 10. The reader 36 would work like a credit card, smart card, memory card reader, or any other known or future identification reader methods. Thus, each user would have an individual card 46, which is used to 1) activate the controller module 30, 2) use the reward module 40 to add reward time units to the card, 3) record time units used during activation of the electronic devices 12.

In yet a further embodiment, it is noted that the control system 10 is illustrated as being separate from the electronic devices 12. However, it is contemplated to include the control system 10 within a selected electronic device 12. For example, if the control system 10 were implemented in Nintendo®, there could be a count down timer displayed on the monitor to indicate the amount of time reward units remaining. Upon reaching a low number of reward time units, the game may display options to save the game before executing a shut down sequence. The control of the electronic device would remain the same, in that the access to that device could be shut down for that user.

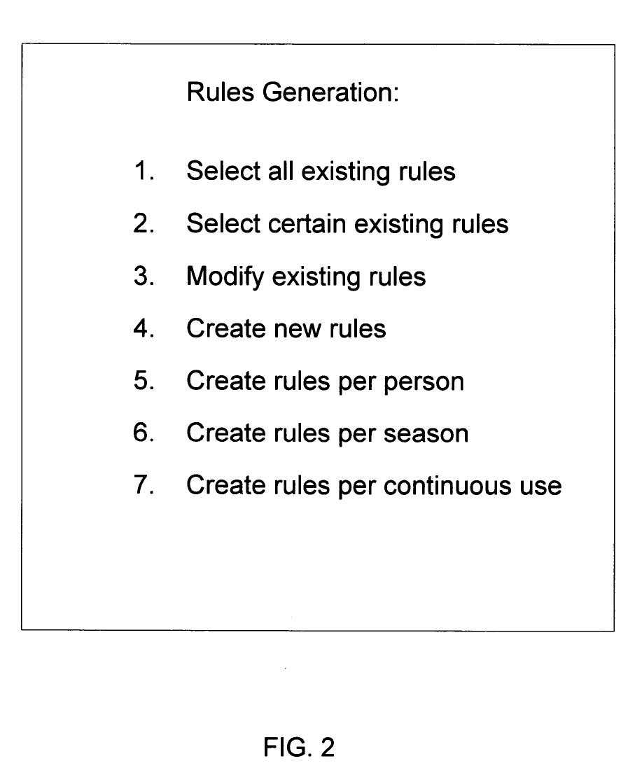

FIG. 2 illustrates specific rule generation options that will be displayed on the screen 34. Uniquely, the manager may select all existing rules, select certain existing rules, modify existing rules, create new rules, create rules per person or user, create rules per season, or create rules per continuous use.

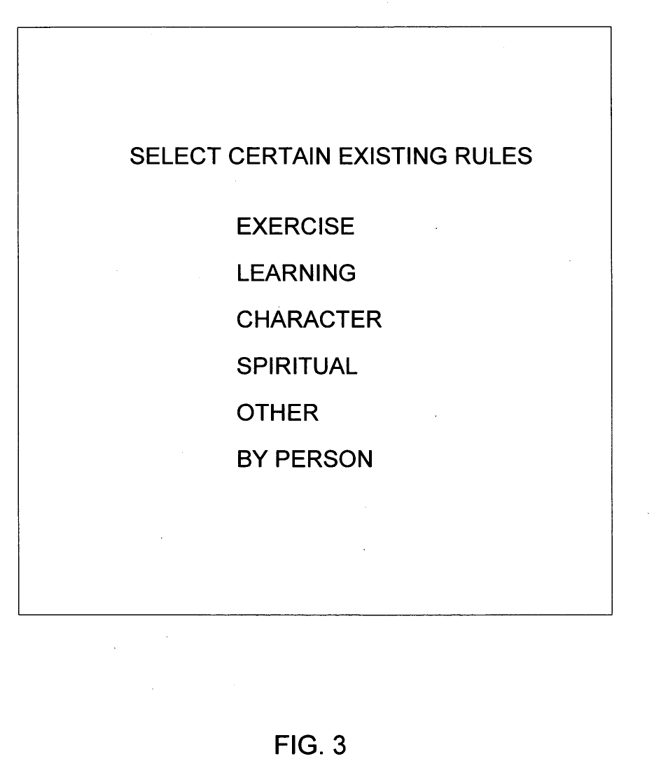

FIG. 3 illustrates a potential list of classes of activities that would be listed on screens 34 or 42, which may be created during the rules creation stage 52 and 54. Specifically, there are listed classes of activities such as exercise, learning, character, spiritual, other, or by person.

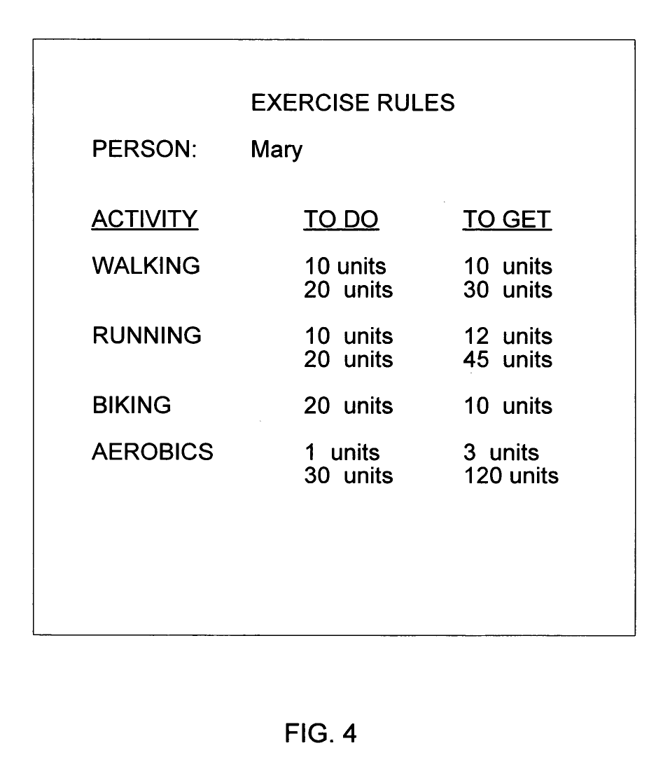

FIG. 4 illustrates one embodiment of the invention related to the specific class of activities related to exercise and provides the related rules for the person named Mary. Uniquely, Mary has four activities: walking, running, biking and aerobics. The specific rules provided for Mary to do walking, for example, if she does 10 units of walking, she receives 10 units of reward time, and 20 units of walking will earn her 30 units of reward time. Additionally, the activity of Biking for 20 units of time will earn 10 units of reward time. Notice that reward units do not need to be equal to the activity performance time. Some reward time may be higher and some lower than the actual time performing the activity. The actual rules are completely adjustable to meet the individual needs of the user. In clarification, the rules are generally defined, by way of this illustration, as the amount of units of time required to perform the particular activity and the calculation for the amount of reward unit time associated with each.

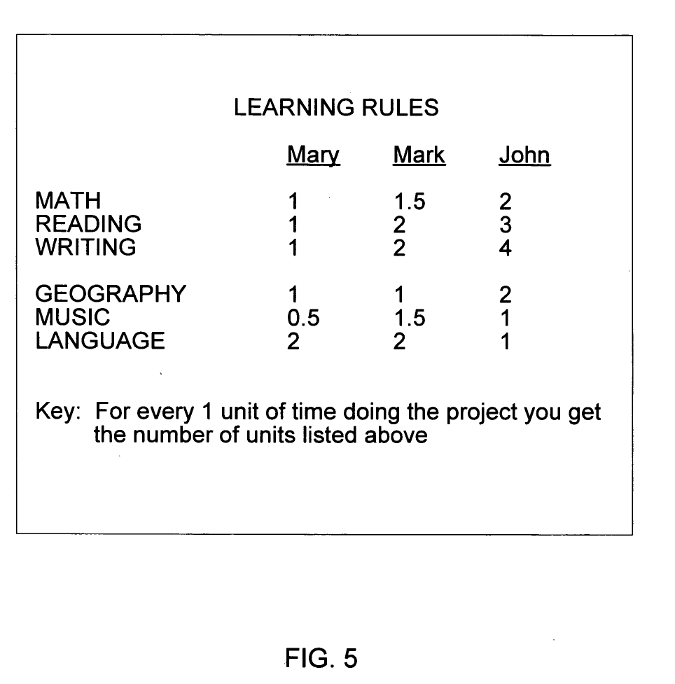

FIG. 5 illustrates the learning rules associated with three different users for the same activities. For example, for performing the writing activity, Mary receives one unit of reward time, Mark receives two units of reward time, and John receives four units of reward time. This illustrates, again, that the rules are completely adjustable to the individual. This further illustrates that there would be three different access codes so that the three listed individuals would have three different reward unit accounts to access the electrical devices 12. This example also illustrates that it is possible to display the same activities for different people.

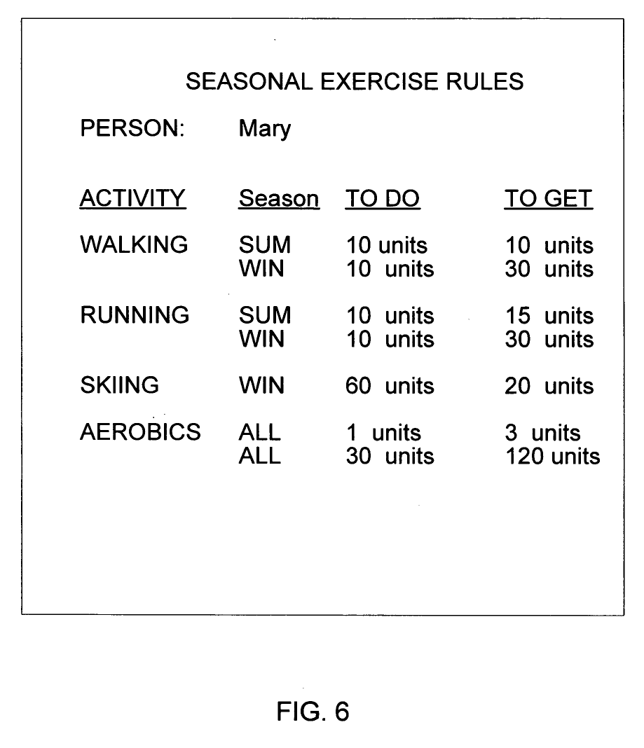

FIG. 6 illustrates the seasonal exercise rules associated for Mary. For example, Mary would have different rules for summer (SUM) and winter (WIN) for the same activity. Specifically, running in summer provides 15 reward units while running in winter will provide 30 reward units for the same 10 units of running. The reasoning for this could be that running for Mary may be harder to do in the winter and thus it is determined to increase the rewards for her when she runs in the winter.

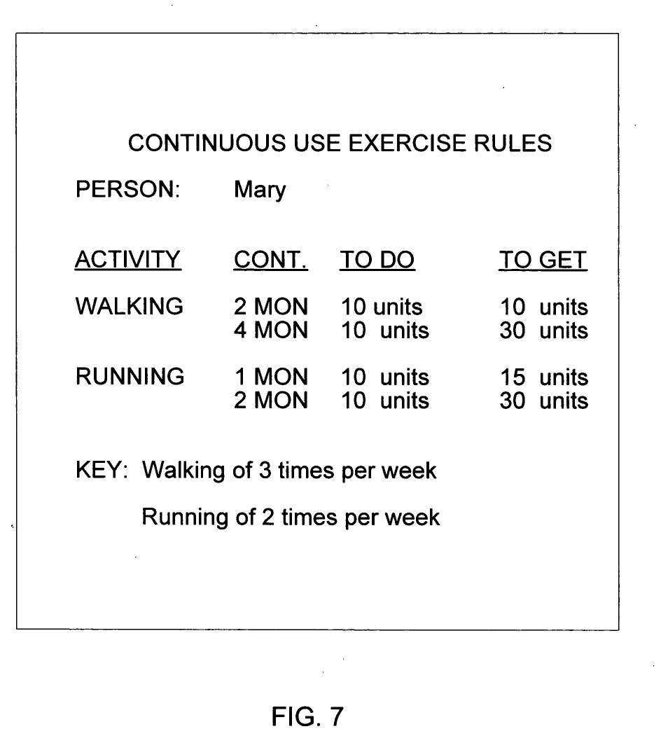

FIG. 7 illustrates the rules for performing an activity for a continuous amount of time for Mary. For example, Mary would receive 15 units of reward time for 10 units of running time if she has been continuously running for less than a month (1 MON). However, once her continuous running activities have exceeded two months (2 MON), her reward has increased to thirty units of reward time for the same 10 units of running time. Thus, the rules programming steps allow for calculations for continuous performance of a desired activity.

In a further embodiment of the illustrated invention, it is contemplated to optionally include a base amount of reward time units on a scheduled time period, like on a weekly basis. Thus, there would be an allowance of reward time units provided that is not dependent upon performing any activity, and is merely provided every Monday, for example. The individual amount of time reward units obviously could be different for each user.

In yet an additional embodiment of the illustrated invention, it is contemplated to optionally include reward calculations and rules for weight loss. Thus, if Mary, for example, needed to watch her weight, she could receive an additional weekly allowance for not exceeding a certain weight. Of course, this rule could account for different levels of weight maintenance with different reward time units available for each level. For example, 50 reward units for keeping a weight of 145#, and 75 reward units for keeping a weight of 140#, etc. Additionally, if Mary needed to loose weight, she could receive reward time units for every amount of weight that she has lost in a given time period.

It is a further embodiment of the invention to provide the ability to suspend a certain user's access to the electronic equipment 12. This could be done in any number of known ways. For example, the control module 30, the reward module 40 or the tracking module 50 could have the particular user identification code suspended for a certain amount of time or permanently removed.

Another embodiment of the invention also contemplates allowing the manager to deduct amounts of reward time units from any particular user.

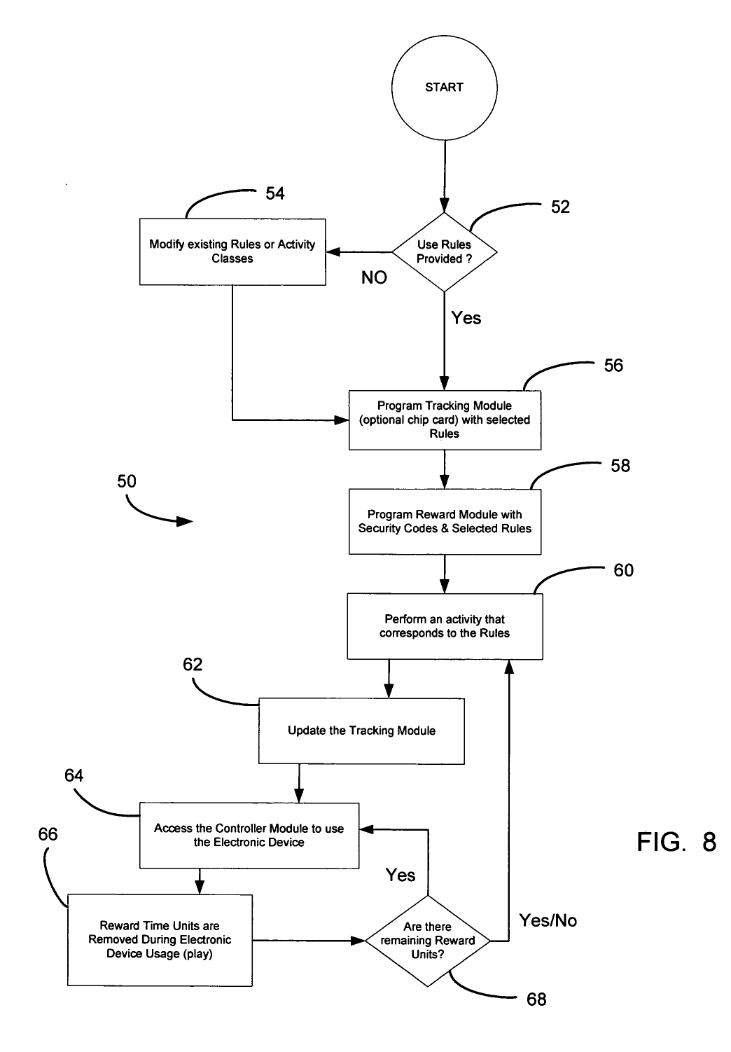

FIG. 8 is a flow chart illustrating the general operation 50 of the illustrated embodiment 10. Specifically, the manager of the rules will interact with the screen 42 and would be taken through a series of screens to establish the initial classes of activities and specific rules as previously illustrated in FIGS. 2-7. The step is to determine if the manager wants to use the existing pre-programmed rules 52, if not, the manager is allowed to modify the classes of activities and specific rules 54. Specifically, the manager would be able to add new rules or classes, modify the existing rules or classes, and keep intact other rules or classes of activities.

Continuing the description of FIG. 8, after the rules are established, the rules tracking module 56, which may be the card 46, is loaded with the appropriate rules information. One embodiment for loading rules could include the use of smart cards, or chip imbedded cards, or other portable piece capable of having the rules loaded thereon. The smart card 46 is then intended to hold specific rules related to the specific user. Where each card 46 would contain different rules and stored reward time.

FIG. 8 further illustrates the step of programming the reward module 40 with individual security codes and selected rules associated with the individual 58. Specifically, programming the individual security codes includes creating codes for both the individual using the rules to access the electronic devices 12 and the individual responsible for managing the compliance with the rules and entering time rewards accordingly. Obviously, the managing person should have an entry code that is to be entered before they can give reward time to the user for performing the activity that earns them the reward time. That reward time will then be stored for the particular user to access the electronic devices 12 for a given amount of time. The reward time may be stored on the card 46, may be stored in the controller module 30, or reward module 40, or may be stored as a separate module.

FIG. 8 additionally illustrates the step of performing an activity that corresponds to the rules 60. This is where the user selects a particular class of activity and selects a particular activity to perform for a designated unit of time. Thereafter, the manager will update 62 the tracking module, which may be the card 46 or just entering the user's code in the controller module 30 as previously described, to access the rules that are tailored to the user. The manager then enters their personal access codes to enable the manager to enter the units of time performed by the user for the specific activity, like running for Mary. The reward module 40 will then add the corresponding reward units of time to the tracking module, or card 46. Next, the user is free to access the controller module 30 to enable the electronic device 12 to be played by the user for the amount of reward time units 64. Once the user accesses the controller module 30, reward units are removed from the tracking module during electronic device usage 66. When the user disengages from the electronic device, the user may reengage the electronic device 12 if there are any remaining reward units of time, or they may perform other classes of activities to gain additional reward units of time 68.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An electronic device control system for controlling access to an electrical device, comprising:
a controller module functionally coupled to the electrical device, designed to limit access to the electrical device, including:
a power plug designed to access electrical power for the controller module;
a plug locking mechanism coupled to the controller module, and designed to hinder removal of the electrical device power cord when inserted therein;
an interface screen designed to allow programming of the controller module
a tracking module designed to keep track of the amount of reward time a user has available to use in accessing the electronic device; and
a reward module designed to enable a manager to add reward time to a user for performing selected activities.

2. The system of claim 1, wherein the this locking mechanism could be as simple as a combination lock.

3. The system of claim 1, wherein the reward module could be imbedded in the same device as containing the controller module.

4. The system of claim 3, wherein the interface is a screen that listed classes of activities selected from the group consisting of: exercise, learning, character, spiritual, other, or by person.

5. The system of claim 1, wherein the interface is a screen that lists the class of exercise with activities selected from the group consisting of: walking, running, biking and aerobics.

6. The system of claim 5, wherein the interface is a screen that lists the activity of walking has a rule that provides 10 units of reward time for 10 units of walking time, and 20 units of walking time will provide 30 units of reward time to be added to the tracking module.

7. The system of claim 5, wherein the interface is a screen that lists the class of learning and lists the activities selected from the group consisting of math, reading, writing, geography, music, or language.

8. The system of claim 5, wherein the interface is a screen that lists the class of exercising and lists the activities of seasonal exercise rules where running in summer provides 15 reward units while running in winter will provide 30 reward units for a same 10 units of running.

9. The system of claim 5, wherein the interface is a screen that lists the class of exercise and lists the activities of seasonal exercise rules where 15 units of reward time is provided for 10 units of running time if running has been continuously done for less than a month, and when there has been continuous running activities for two months or more the reward time is increased to thirty units of reward time for the same 10 units of running time.

10. A method for an electronic device control system for controlling access to an electrical device, comprising the steps of:
providing a controller module functionally coupled to the electrical device, designed to limit access to the electrical device, including:
providing a power plug designed to access electrical power for the controller module;
providing a plug locking mechanism coupled to the controller module, and designed to hinder removal of the electrical device power cord when inserted therein;
providing an interface screen designed to allow programming of the controller module
providing a tracking module designed to keep track of the amount of reward time a user has available to use in accessing the electronic device; and
providing a reward module designed to enable a manager to add reward time to a user for performing selected activities.

11. The method of claim 10, wherein the this locking mechanism could be as simple as a combination lock.

12. The method of claim 10, wherein the reward module could be imbedded in the same device as containing the controller module.

13. The method of claim 12, wherein the interface is a screen that listed classes of activities selected from the group consisting of: exercise, learning, character, spiritual, other, or by person.

14. The method of claim 10, wherein the interface is a screen that lists the class of exercise with activities selected from the group consisting of: walking, running, biking and aerobics.

15. The method of claim 14, wherein the interface is a screen that lists the activity of walking has a rule that provides 10 units of reward time for 10 units of walking time, and 20 units of walking time will provide 30 units of reward time to be added to the tracking module.

16. The method of claim 14, wherein the interface is a screen that lists the class of learning and lists the activities selected from the group consisting of math, reading, writing, geography, music, or language.

17. The method of claim 14, wherein the interface is a screen that lists the class of exercising and lists the activities of seasonal exercise rules where running in summer provides 15 reward units while running in winter will provide 30 reward units for a same 10 units of running.

18. The method of claim 14, wherein the interface is a screen that lists the class of exercise and lists the activities of seasonal exercise rules where 15 units of reward time is provided for 10 units of running time if running has been continuously done for less than a month, and when there has been continuous running activities for two months or more the reward time is increased to thirty units of reward time for the same 10 units of running time.
